(19) United States
(12) Patent Application Publication
(10) Pub. No.: US 2021/0059786 A1
(43) Pub. Date: Mar. 4, 2021

(54) Endodontic Instrument Extraction Tool

(71) Applicant: Kelly Coeur, Vine Grove, KY (US)

(72) Inventor: Kelly Coeur, Vine Grove, KY (US)

(21) Appl. No.: 16/990,221

(22) Filed: Aug. 11, 2020

Related U.S. Application Data
(60) Provisional application No. 62/892,091, filed on Aug. 27, 2019.

(51) Int. Cl. A61C 5/46; A61C 5/42

(52) U.S. Cl. CPC A61C 5/46; A61C 5/42

(57) ABSTRACT

An endodontic instrument extraction tool is provided. The device includes a housing having a first end opposite a second end and a sidewall extending therebetween, defining an interior volume. A grasping mechanism is disposed within the interior volume, wherein the grasping mechanism includes a plurality of arms selectively movable between an open position and a closed position. A distance between each of the plurality of arms is minimized when the plurality of arms is in the closed position. A rotatable member is disposed within the first end of the housing and is operably connected to the grasping mechanism, such that the plurality of arms move towards the closed position when the rotatable member is rotated in a first direction and move towards the open position when the rotatable member is rotated in a second direction.

### CROSS REFERENCE TO RELATED APPLICATIONS

This application claims the benefit of U.S. Provisional Application No. 62/892,091 filed on Aug. 27, 2019. The above identified patent application is herein incorporated by reference in its entirety to provide continuity of disclosure.

### BACKGROUND OF THE INVENTION

The present invention relates to endodontic tools. More particularly, the present invention pertains to an endodontic instrument extraction tool configured to allow a user to grasp and remove desired items such as pieces of endodontic instruments from within a tooth.

Root canal procedures are frequently performed in order to repair a tooth that is infected or badly decayed. During a root canal, the nerve and pulp within a tooth is removed and the tooth is sealed to prevent the spread of infection. In order to do so, endodontic files are used. These endodontic files typically have a thin cross-section in order to reach the various tight confines of the tooth interior. Due to the thinness of the files, such endodontic files are typically very fragile and may break into one or more pieces during use, leaving sections of the file embedded within the tooth. Removing the broken file sections may be difficult and leaving the broken file sections within the tooth compromises the long-term prognosis of the tooth. Sometimes, the only method for removing the broken file sections from the tooth is surgery, which can cause excess pain or recovery time for the patient. Therefore, a device that can grasp and remove a desired item such as a piece of an endodontic instrument from within the tooth is desired.

In light of the devices disclosed in the known art, it is submitted that the present invention substantially diverges in design elements from the known art and consequently it is clear that there is a need in the art for an improvement to existing endodontic tools. In this regard, the instant invention substantially fulfills these needs.

### SUMMARY OF THE INVENTION

In view of the foregoing disadvantages inherent in the known types of endodontic tools now present in the known art, the present invention provides an endodontic instrument extraction tool wherein the same can be utilized for providing convenience for the user when removing desired items such as fragments of endodontic instruments from the interior of a tooth.

The present system comprises a housing having a first end opposite a second end with a sidewall extending therebetween, thereby defining an interior volume. A grasping mechanism is disposed within the interior volume, wherein the grasping mechanism comprises a plurality of arms selectively movable between an open position and a closed position. A distance between each of the plurality of arms is minimized when in the closed position. A rotatable member is disposed within the first end of the housing and is operably connected to the grasping mechanism, such that when the rotatable member is rotated in a first direction, the plurality of arms move towards the closed position, and when the rotatable member is rotated in a second direction, the plurality of arms move towards the open position. In some embodiments, the rotatable member is removably securable to a working end of a dental handpiece, the dental handpiece including a motor that selectively rotates the rotatable member in the first and second directions. In another embodiment, each of the plurality of arms comprise an arcuate shape, such that the plurality of arms defines a circular cross-section when in the closed position. In other embodiments, an interior surface of each of the plurality of arms comprises a textured surface configured to frictionally engage an item therebetween. In yet another embodiment, a notch is disposed within the first end of the housing, wherein the notch is configured to frictionally engage within the working end of a tool, such as the dental handpiece. In some embodiments, a distal end of each of the plurality of arms extends beyond the second end of the housing. In another embodiment, the second end of the housing includes a cutting bur thereon. In other embodiments, the housing is arcuate, such that the first end and the second end are not coaxially aligned. In yet another embodiment, an exterior surface of each of the plurality of arms tapers inwardly towards an interior surface at a distal end thereof. In some embodiments, an internal coupling member is operably connected to the rotating member, wherein the internal coupling member selectively expands and constricts a ring clamp disposed about a proximal end of each of the plurality of arms, wherein the plurality of arms are moved to the closed position when the ring clamp is constricted.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of an embodiment of the endodontic instrument extraction tool.

FIG. 16 shows a perspective view of an alternate embodiment of the endodontic instrument extraction tool.

FIG. 2A shows a close-up view of the plurality of arms of an embodiment of the endodontic instrument extraction tool in an open position.

FIG. 2B shows a close-up view of the plurality of arms of an embodiment of the endodontic instrument extraction tool in a partially closed position.

FIG. 3 shows a cross-sectional view of an embodiment of the endodontic instrument extraction tool.

FIG. 4 shows a cut-away view of an embodiment of the endodontic instrument extraction tool in use.

### DETAILED DESCRIPTION OF THE INVENTION

Reference is made herein to the attached drawings. Like reference numerals are used throughout the drawings to depict like or similar elements of the endodontic instrument extraction tool. The figures are intended for representative purposes only and should not be considered to be limiting in any respect.

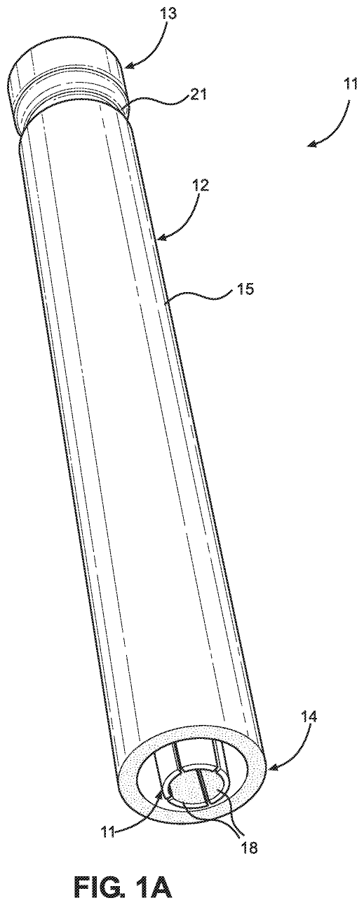

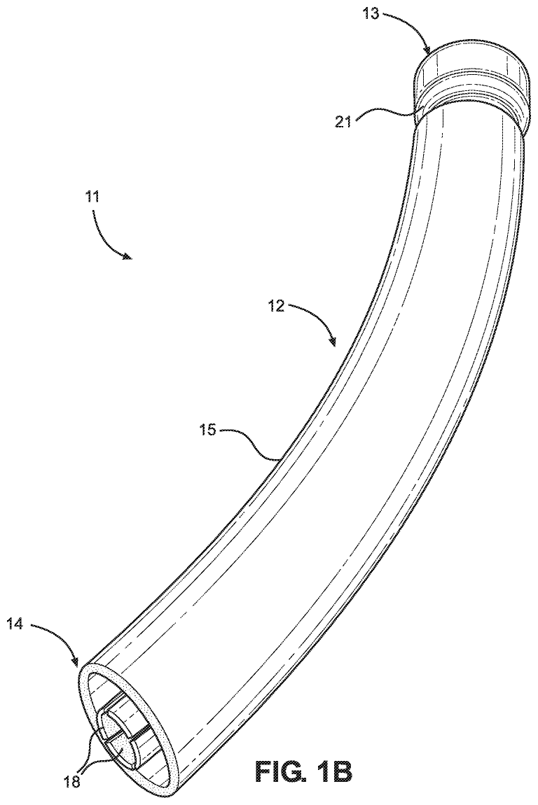

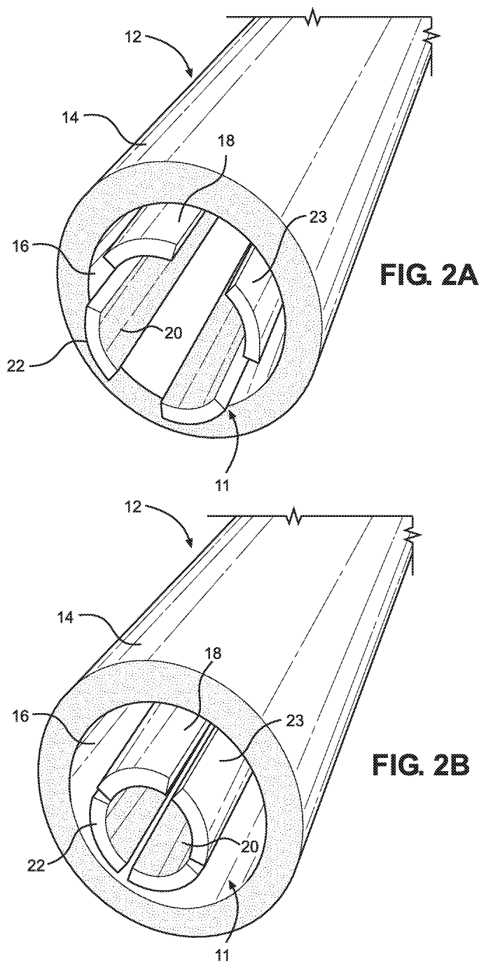

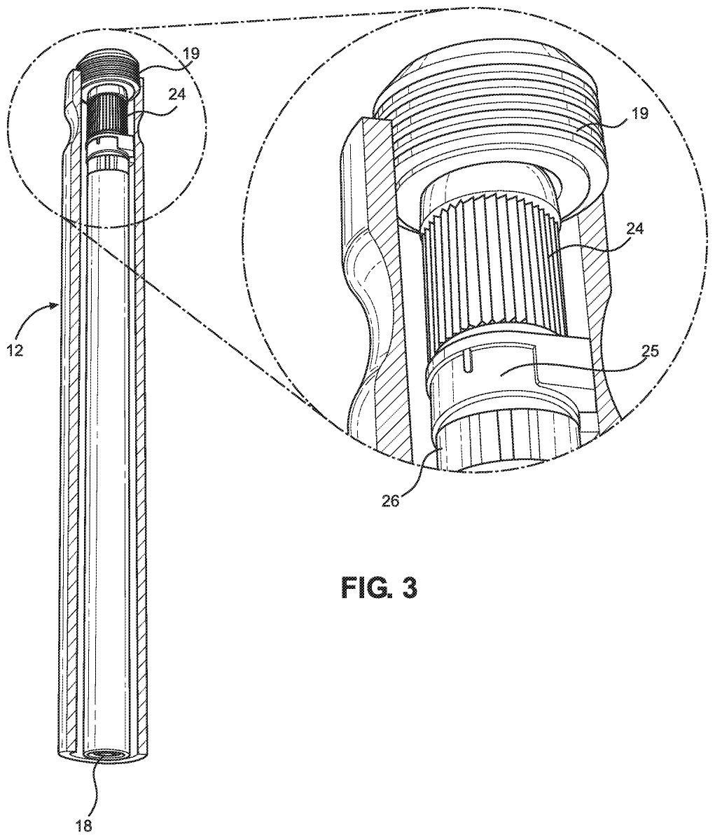

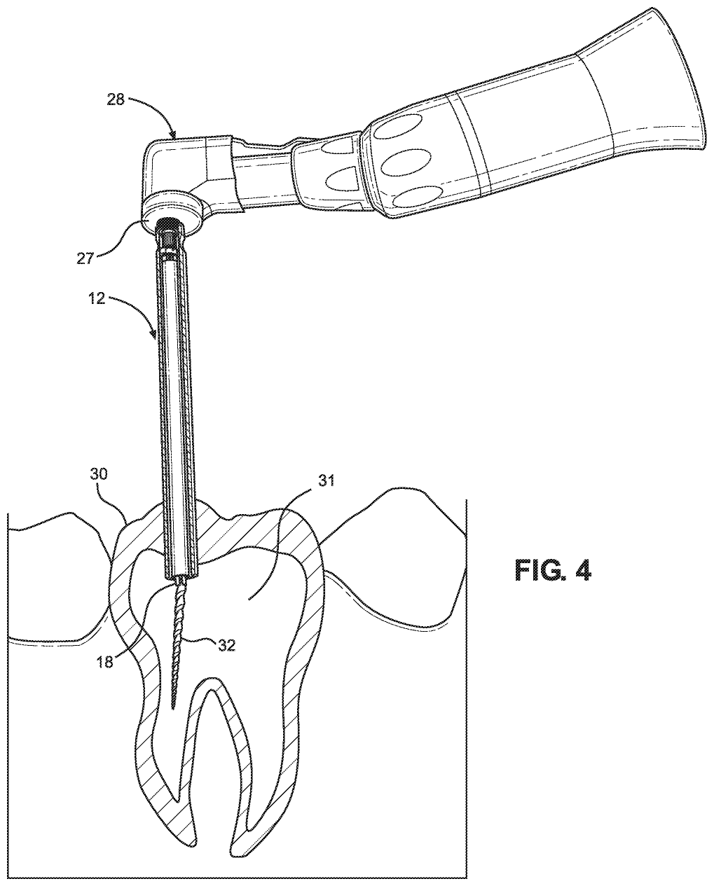

Referring now to FIGS. 1A and 1B, there is shown a perspective view of an embodiment of the endodontic instrument extraction tool and a perspective view of an alternate embodiment of the endodontic instrument extraction tool, respectively. The endodontic instrument extraction tool 11 comprises a housing 12 having a first end 13 opposite a second end 14 having a sidewall 15 extending therebetween, thereby defining an interior volume (as shown in FIGS. 2A and 2B, 16). The housing 12 is contemplated to comprise a variety of sizes and internal diameters to be utilized in combination with various endodontic tool sizes, such as varying width of endodontic files. In this manner, the user can select a desired housing 12 to reach an interior of a tooth to retrieve a broken endodontic tool, such as a tip of an endodontic file therefrom. In the illustrated embodiment of FIG. 1A, the housing 12 comprises a linear form factor such that the first and second ends 13, 14 are coaxially aligned, providing the user with a direct path to retrieve an endodontic tool, whereas, in the shown embodiment of the FIG. 1B, the housing 12 comprises an arcuate form factor wherein the first and second ends 13, 14 are not coaxially aligned. The arcuate embodiment of FIG. 1B provides a user with greater maneuverability, allowing the housing 12 to reach areas within a tooth otherwise inaccessible through a previously drilled entry point, or to retrieve an endodontic file within a rearward tooth, such as a molar.

A grasping mechanism is disposed within the interior volume of the housing 12, wherein the grasping mechanism is configured to secure an item, such as an endodontic file, therein. The grasping mechanism comprises a plurality of arms 18 extending between the first end 13 and the second end 14 of the housing 12. The plurality of arms 18 are selectively movable between an open position and a closed position, wherein the closed position a linear distance between each of the plurality of arms 18 is minimized such that the plurality of arms 18 are configured to grasp an item therebetween. In the illustrated embodiment, a distal end (as shown in FIGS. 2A and 21, 22) of each of the plurality of arms 18 extends beyond the second end 14 of the housing 12. In this manner, the plurality of arms 18 are the first point of contact within the tooth body such that the user can easily identify that the endodontic file or other item within the tooth interior is contacting the plurality of arms 18 when resistance is first encountered, rather than the housing 12. Additionally, in such embodiments, the user need not thread the endodontic file within the housing 12 followed by the plurality of arms 18. The grasping mechanism is further operably connected to a rotating member (as shown in FIG. 3, 19), wherein the rotating member is configured to selectively move the plurality of arms 18 between an open position and a closed position when rotated. The rotating member can further be operably connected to a working end of a tool handle, such that the user can rotate the rotating member therewith. In the shown embodiments, the first end 13 further comprises a notch 21 therein, wherein the notch 21 is dimensioned to frictionally engage within a working end of a tool handle, such as a manual or motorized dental handpiece. In this manner, the user can operably connect an existing dental handpiece to the rotating member to control the plurality of arms 18.

Referring now to FIGS. 2A and 2B, there is shown a close-up view of the plurality of arms of an embodiment of the endodontic instrument extraction tool in an open position and a close-up view of the plurality of arms of an embodiment of the endodontic instrument extraction tool in a partially closed position, respectively. In the shown embodiment, the plurality of arms 18 are selectively movable between an open position (as shown in FIG. 2A) and a closed position (as shown in FIG. 2B), wherein a linear distance between each of the plurality of arms 18 is minimized when in the closed position to facilitate grasping of a desired item therebetween. When in the open position, the plurality of arms 18 are separated to allow a user to place an item therebetween. In the illustrated embodiment, the plurality of arms 18 each comprise an arcuate segment such that the plurality of arms 18 define a circular cross-section. In this manner, the plurality of arms 18 are dimensioned to conform to the typical shape of existing endodontic files to maximize contact surface area therewith. While the shown embodiment encompasses a preferred embodiment to grasp endodontic files, one having skill in the art will appreciate that alternate styles of arm geometry for maximizing contact surface area with various items are also contemplated. In the shown embodiment, an interior surface 20 of each of the plurality of arms 18 comprises a textured surface configured to increase surface area in contact with an item such as an endodontic file. Alternatively, the interior surface 20 can comprise a plurality of teeth or ridges to accomplish the same task. In this manner, frictional engagement with the endodontic file is maximized. In some embodiments, the plurality of arms 18 further comprise a taper extending between an exterior surface 23 of each of the plurality of arms 18 towards the interior surface 20, such that an edge is defined along the interior surface 20 of the distal end 22. In this manner, the leading edge of each of the plurality of arms 18 defines a minimal cross-section to allow the plurality of arms 18 to cut through pulp or other material within the tooth interior.

In the shown embodiment, the second end 14 of the housing 12 further comprises a cutting bur comprising a rough or textured surface, such as a diamond grit, thereon. In this embodiment, the cutting bur comprises an end cutting bur disposed solely along a forward surface of the second end 14, however, in other embodiments, the cutting bur extends along an exterior of the housing 12 to allow the user to utilize the sides of the second end 14 to cut away portions of the tooth that may pose an obstacle to the removal of an inadvertently embedded endodontic file. In other embodiments, the second end 14 flares outward relative to a longitudinal axis of the housing 12, such that the second end 14 comprises a greater diameter than that of the first end 13. In this way, the cutting bur disposed on the second end 14 comprises a larger surface area, allowing a user to cut away portions of tooth more easily.

Referring now to FIG. 3, there is shown a cross-sectional view of an embodiment of the endodontic instrument extraction tool. In the illustrated embodiment, the plurality of arms 18 extends along a longitudinal axis of the housing 12, wherein the plurality of arms 18 are operably connected to a rotating member 19 disposed within the first end of the housing 12. The rotating member 19 is configured to removably secure to a working end (as shown in FIG. 4, 27) of a tool, such as a dental handpiece (as shown in FIG. 4, 28), such that the user can utilize the tool to rotate the rotating member 19 to selectively open and close the plurality of arms 18. When rotated in a first direction, the rotating member 19 causes the plurality of arms 18 to move towards the closed position, whereas when the rotating member 19 is rotated in a second direction, the plurality of arms 18 are moved towards the open position. A variety of mechanisms known in the art for translating the rotation of the working end of a tool into opening and closing the plurality of arms 18 are contemplated. In the shown embodiment, the rotating member 19 is operably connected to an internal coupling member 24 configured to selectively constrict or expand a ring clamp 25 disposed about a proximal end 26 of each of the plurality of arms 18. In such an embodiment, the plurality of arms 18 are connected at the proximal end in a spring-biased manner, such that the plurality of arms 18 are biased towards the open position. In this way, when the ring clamp 25 is expanded, the plurality of arms 18 move towards the open position. In some embodiments, the internal coupling member 24 is configured to rotate in a direction opposite that which the rotating member 19 is rotated. In the shown embodiment, the rotating member 19 includes a connector thereon, wherein the connector is configured to removably secure the housing 12 to the working end of an existing dental tool, such as a motorized dental handpiece or latch slow motor handpiece. Such handpieces are capable of rotating the working end thereof in either a clockwise or counterclockwise direction, such that the handpiece can be utilized to open and close the plurality of arms 18.

Referring now to FIG. 4, there is shown a cut-away view of an embodiment of the endodontic instrument extraction tool in use. In one use, the housing 12 is secured to the working end 27 of an existing dental handpiece 28, such that the working end 27 can rotate the rotating member within the housing 12 to selectively open and close the plurality of arms 18. In the illustrated embodiment, the dental handpiece 28 comprises a motorized dental handpiece 28 configured to rotate the working end 27 in clockwise and counterclockwise directions. Alternate dental handpieces 28 are contemplated, such as a manual handpiece allowing a user to rotate the rotating member manually. The housing 12 is then inserted into an existing drilled hole within a tooth 30 to provide access to an interior 31 of the tooth 30. The plurality of arms 18 are placed about a broken segment of an endodontic file 32 or another item embedded within the tooth 30. Once placed about the endodontic file 32, the plurality of arms 18 are moved to the closed position via actuation of the dental handpiece 28, such that the plurality of arms 18 engage the endodontic file 32 segment therebetween. In some cases, portions of the tooth 30 or pulp disposed within the interior 31 of the tooth 30 must be removed to reach the embedded endodontic file 32. In such cases, an end cutting bur disposed on the distal end of the housing 12 can be used to cut away the portions of the tooth 30 which otherwise prevent access to the endodontic file 32. Once the endodontic file 32 is secured between the plurality of arms 18, the housing 12 can be extracted from the interior 31 of the tooth 30. After extraction, the endodontic file 32 segment can be released from the plurality of arms 18 via rotating the working end 27 of the dental handpiece 28 in the opposite direction.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An endodontic instrument extraction tool, comprising:
a housing having a first end opposite a second end and a sidewall extending therebetween, defining an interior volume;
a grasping mechanism disposed within the interior volume;
wherein the grasping mechanism comprises a plurality of arms selectively movable between an open position and a closed position;
wherein a distance between each of the plurality of arms is minimized when in the closed position;
a rotatable member disposed within the first end of the housing and operably connected to the grasping mechanism;
wherein the plurality of arms moves towards the closed position when the rotatable member is rotated in a first direction and move towards the open position when the rotatable member is rotated in a second direction.

2. The endodontic instrument extraction tool of claim 1, wherein each of the plurality of arms comprise an arcuate shape, such that when in the closed position, the plurality of arms defines a circular cross-section.

3. The endodontic instrument extraction tool of claim 1, wherein an interior surface of each of the plurality of arms comprises a textured surface configured to frictionally engage an item therebetween.

4. The endodontic instrument extraction tool of claim 1, further comprising a notch disposed within the first end of the housing, wherein the notch is configured to engage the housing within a working end of a tool.

5. The endodontic instrument extraction tool of claim 1, wherein a distal end of each of the plurality of arms extends beyond the second end of the housing.

6. The endodontic instrument extraction tool of claim 1, wherein the second end of the housing includes a cutting bur thereon.

7. The endodontic instrument extraction tool of claim 1, wherein the housing is arcuate, such that the first end and the second end are not coaxially aligned.

8. The endodontic instrument extraction tool of claim 1, further comprising an internal coupling member operably connected to the rotating member, wherein the internal coupling member selectively expands and constricts a ring clamp disposed about a proximal end of each of the plurality of arms, wherein the plurality of arms are moved to the closed position when the ring clamp is constricted.

9. An endodontic instrument extraction tool, comprising:
a housing having a first end opposite a second end and a sidewall extending therebetween, defining an interior volume;
a grasping mechanism disposed within the interior volume;
wherein the grasping mechanism comprises a plurality of arms selectively movable between an open position and a closed position;
wherein a distance between each of the plurality of arms is minimized when in the closed position;
a rotatable member disposed within the first end of the housing and operably connected to the grasping mechanism;
wherein the plurality of arms moves towards the closed position when the rotatable member is rotated in a first direction and move towards the open position when the rotatable member is rotated in a second direction;
wherein the rotatable member is removably securable to a working end of a dental handpiece;
wherein the dental handpiece includes a motor configured to selectively rotate the rotatable member in the first direction and the second direction.

10. The endodontic instrument extraction tool of claim 9, wherein each of the plurality of arms comprise an arcuate shape, such that when in the closed position, the plurality of arms defines a circular cross-section.

11. The endodontic instrument extraction tool of claim 9, wherein an interior surface of each of the plurality of arms comprises a textured surface configured to frictionally engage an item therebetween.

12. The endodontic instrument extraction tool of claim 9, further comprising a notch disposed within the first end of the housing, wherein the notch is configured to engage the housing within the working end of the dental handpiece.

13. The endodontic instrument extraction tool of claim 9, wherein a distal end of each of the plurality of arms extends beyond the second end of the housing.

14. The endodontic instrument extraction tool of claim 9, wherein the second end of the housing includes a cutting bur thereon.

15. The endodontic instrument extraction tool of claim 9, wherein the housing is arcuate, such that the first end and the second end are not coaxially aligned.

16. The endodontic instrument extraction tool of claim 9, further comprising an internal coupling member operably connected to the rotating member, wherein the internal coupling member selectively expands and constricts a ring clamp disposed about a proximal end of each of the plurality of arms, wherein the plurality of arms are moved to the closed position when the ring clamp is constricted.

17. A method for using an endodontic instrument extraction tool, comprising:
providing a housing having a grasping mechanism disposed within an interior volume of the housing;
inserting the housing into an interior of a tooth;
placing a plurality of arms defining the grasping member about a desired item embedded within the tooth;
rotating a rotating member, wherein the rotating member is disposed on a first end of the housing and operably connected to the grasping mechanism, such that the plurality of arms moves towards a closed position, thereby frictionally engaging the endodontic file therebetween;
extracting the endodontic file from the tooth by removing the housing therefrom.

18. The method of claim 17, further comprising cutting away a portion of the tooth via a cutting bur disposed on a second end of the housing.
